(19) United States
(12) Patent Application Publication
(10) Pub. No.: US 2009/0010836 A1
(43) Pub. Date: Jan. 8, 2009

(54) HYDROGEN STORAGE MATERIALS, METAL HYDRIDES AND COMPLEX HYDRIDES PREPARED USING LOW-BOILING-POINT SOLVENTS

(75) Inventors: Gerard Sean McGrady, Lincoln (CA); Craig M. Jensen, Kailua, HI (US)

Correspondence Address: Hiscock & Barclay, LLP, One Park Place, 300 South State Street, Syracuse, NY, 13202-2078, US

(73) Assignee: HSM Systems, Inc., Fredericton (CA)

(21) Appl. No.: 12/143,348

(22) Filed: Jun. 20, 2008

Related U.S. Application Data
(60) Provisional application No. 60/945,650, filed on Jun. 22, 2007.

(51) Int. Cl. C01B 6/04; C01B 6/24

(52) U.S. Cl. 423/646; 423/647; 423/644

(57) ABSTRACT

The invention provides systems and methods for preparing hydrogen storage materials using low boiling point solvents or reaction media. Examples of such solvents or reaction media include dimethyl ether, ethyl methyl ether, epoxyethane, and trimethylamine. The synthesis of the hydrogen storage materials is conducted is a selected medium, and after synthesis is complete, the reaction medium is removed as necessary by moderate heating.

### CROSS-REFERENCE TO RELATED APPLICATIONS

This application claims priority to and the benefit of co-pending U.S. provisional patent application Ser. No. 60/945,650, filed Jun. 22, 2007, which application is incorporated herein by reference in its entirety.

### FIELD OF THE INVENTION

The invention relates to systems and methods for the low temperature synthesis of materials in general and particularly to systems and methods useful for chemical synthesis that employ reaction media having boiling points below room temperature, e.g., substantially 298 K or 25° C.

### BACKGROUND OF THE INVENTION

Hydrogen storage materials or media (HSMs) are a class of chemicals containing hydrogen in a chemically or physically bound form. They have wide potential utility in the areas of transportation, materials manufacture and processing and laboratory research. There is particular current interest in HSMs for the first application: fuel cell-powered vehicles for use in a ‘hydrogen economy’ require an on-board source of hydrogen fuel, and hydrogen is very difficult to store either as a gas or as a cooled liquid to provide sufficient distance between refills.

Despite optimism over the last three decades, a hydrogen economy remains a utopian vision. The US Department of Energy (DOE) Basic Science group published a landscape report in 2003 summarizing the fundamental scientific challenges that must be met before a hydrogen economy becomes viable. The report identifies the following desiderata for a viable HSM:

1. High hydrogen storage capacity (minimum 6.5 wt % H).

2. Low H₂ generation temperature (T_{dec} ideally in the range of approximately 60-120° C.).

3. Favorable kinetics for H₂ adsorption/desorption.

4. Low cost.

5. Low toxicity and low hazards.

Many materials show considerable promise as HSMs, but cannot be prepared in a solvent-free state by conventional methods. For example, Mg(AlH₄)₂ has a hydrogen content of 9.3 wt %, and releases H₂ at relatively low temperatures, as described in Eqs. 1 and 2.

$$\begin{matrix}{Mg ( {AlH}_{4} )}_{2 ( s )} {}^{165 ° C . } {MgH}_{2 ( s )} + 2 {Al}_{( s )} + 3 {H}_{2 ( g )} & Eq . 1 \\ {MgH}_{2 ( s )} {}^{240 ° C .} {Mg}_{( s )} + {H}_{2 ( g )} & Eq . 2\end{matrix}$$

Mg(AlH₄)₂ has previously been prepared by metathesis reactions of the sort described in Eqs. 3 and 4, employing conventional ether solvents selected from one of tetrahydrofuran, C₄H₈O; THF, and diethyl ether, (C₂H₅)₂O.

$$\begin{matrix} 2 {NaAlH}_{4 ( s )} + {MgCl}_{2 ( s )} {}^{THF} {Mg ( {AlH}_{4} )}_{2} \cdot 4 {THF}_{( s )} + 2 {NaCl}_{( s )} & Eq . 3 \\ 2 {LiAlH}_{4 ( s )} + {MgBr}_{2 ( s )} {}^{{( {C}_{2} {H}_{5} )}_{2} O } {Mg ( {AlH}_{4} )}_{2} \cdot {Et}_{2} {O}_{( s )} + 2 {LiBr}_{( s )} & Eq . 4\end{matrix}$$

However, the use of such solvents has frustrated the development of an efficient process. The ether solvent invariably remains coordinated to the product, proving very difficult to remove below the H₂ desorption temperature, and subsequently contaminating the H₂ released above this temperature.

Metal hydrides and complex metal hydrides have wide utility for synthesis and reduction reactions in both organic and inorganic chemistry. For example, LiAlH₄ can be used in the preparation of many metal hydrides from the corresponding halide, or can be used as reducing agents for a variety of functional groups, as illustrated in FIG. 1.

Currently, LiAlH₄ is prepared by reduction of aluminum chloride, according to Eq. 5.

$$4 {LiH}_{( s )} + {AlCl}_{3 ( s )} {}^{{( E t )}_{2} O } {LiAlH}_{4 ( s )} + 3 {LiCl}_{( s )} \qquad Eq . 5$$

This reaction is only 25% efficient in terms of Li, which is an expensive metal. A more efficient synthesis route would be preferred.

Alane, AlH₃₍ₓ₎, is a polymeric hydride with a hydrogen content of 10.1 wt % and a low hydrogen release temperature. Alane satisfies most of the requirements for a HSM, with the exception of reversibility: the rehydrogenation reaction described in Eq. 6 is thermodynamically unfavorable at ambient pressure and temperature, requiring around 2 kbar hydrogen pressure to become viable.

Al₍ₛ₎+1.5H_{2(g)}→AlH₃₍ₛ₎ Eq. 6

A number of problems in the synthesis of hydrogen storage materials have been observed, such as the difficulty in preparing such materials having substantially no solvent adducted thereto.

There is a need for systems and methods that provide pure solid hydrogen storage materials under more reasonable conditions of temperature and pressure.

### SUMMARY OF THE INVENTION

In one aspect, the invention relates to a process for preparation of a hydrogen storage material. The process comprises the steps of providing a reagent comprising a metal to be incorporated into the hydrogen storage material; providing a source of hydrogen configured to provide hydrogen as a reagent to be incorporated into the hydrogen storage material; providing a solvent or reaction medium having a boiling point below 25° C.; and reacting the hydrogen reagent with the reagent comprising a metal in the solvent or reaction medium. The process generates a quantity of hydrogen storage material.

In one embodiment, the hydrogen storage material comprises a selected one of Mg(AlH₄)₂, Na₃AlH₆, AlH₃, and LiAlH₄. In one embodiment, the solvent or reaction medium having a boiling point below 25° C. is a selected one of dimethyl ether, ethyl methyl ether, epoxyethane, and trimethylamine. In one embodiment, the step of reacting the hydrogen reagent with the reagent comprising a metal in the solvent or reaction medium comprises a metathesis reaction. In one embodiment, the step of reacting the hydrogen reagent with the reagent comprising a metal in the solvent or reaction medium comprises a complexation reaction. In one embodiment, the step of reacting the hydrogen reagent with the reagent comprising a metal in the solvent or reaction medium comprises a direct reaction between hydrogen and a metal to form a metal hydride. In one embodiment, the step of reacting the hydrogen reagent with the reagent comprising a metal in the solvent or reaction medium comprises a direct reaction between hydrogen and a metal to form a complex metal hydride.

In one embodiment, the process for preparation of a hydrogen storage material further comprises the step of removing an adduct molecule of the solvent or reaction medium from the hydrogen storage material to provide the hydrogen storage material in a substantially pure form.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a diagram showing various chemical reactions representing the reduction of organic functional groups by LiAlH₄, which reactions are known in the prior art.

FIG. 2 is a diagram showing a number of x-ray diffraction powder patterns of Na₃AlH₆ prepared under different conditions, according to principles of the invention.

FIG. 3 is a diagram showing additional chemical reactions involving LiAlH₄, which reactions are known in the prior art.

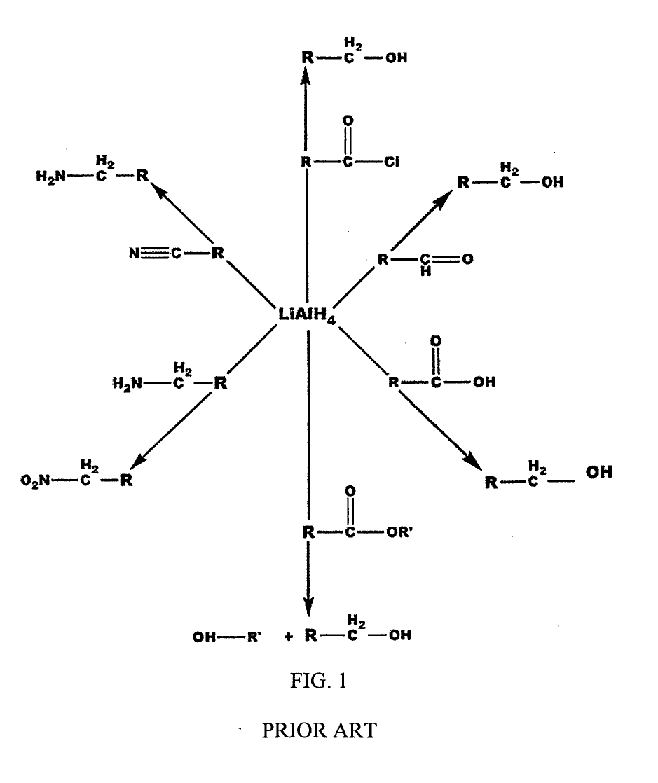

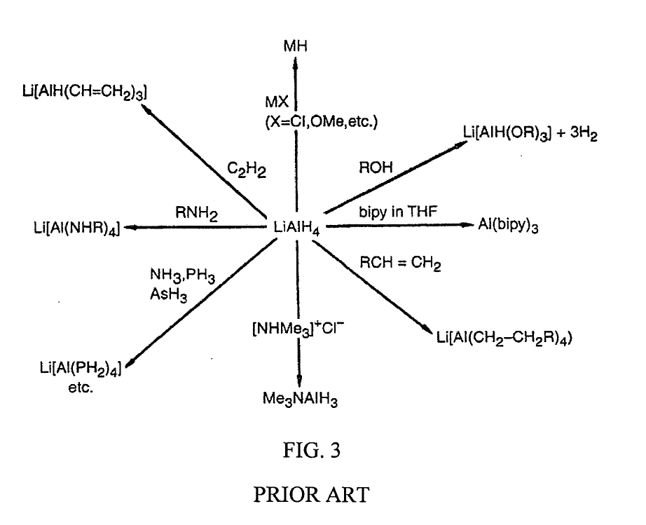

FIG. 1 appears in F. A. Cotton, G. Wilkinson, Advanced Inorganic Chemistry, 5th Edition Wiley Interscience. FIG. 3 appears in F. A. Cotton, G. Wilkinson, C. A. Murillo, M. Bochmann, Advanced Inorganic Chemistry, 6th Edition, John Wiley and Sons, 1999. page 191. See also for example F. A. Cotton, G, Wilkinson, Advanced Inorganic Chemistry, 2nd Edition, 1966, page 447, Interscience Publishers.

### DETAILED DESCRIPTION OF THE INVENTION

The present invention relates to the use of ether and amine solvents with boiling points below ambient temperature (298 K). This class of compounds includes dimethyl ether, Me₂O (b.p. −25° C.); ethyl methyl ether, MeOEt (+11° C.); epoxyethane, C₂H₄O (+10° C.), and trimethylamine, Me₃N (+3° C.).

### Example 1

Solvent-free magnesium alanate can be prepared by using Me₂O as a solvent in place of Et₂O, as described in Eq. 7.

$$2 {LiAlH}_{4 ( s )} + {MgCl}_{2 ( s )} {{}_{25 ° C . ; 4 h }}^{{Me}_{2} O} {Mg ( {AlH}_{4} )}_{2 ( s )} + 2 {LiCl}_{( s )} \qquad Eq . 7$$

Eq. 7 and reactions having a mechanism similar to or analogous to Eq. 7 can be referred to as a metathesis reaction.

The reaction is carried out in a glass H-tube equipped with a sintered glass filter in the bridge. The apparatus is constructed from medium wall Pyrex glass and fitted with high pressure Teflon valves rated to 10 bar pressure. In this way, it can be used to work with liquid Me₂O, which has a vapor pressure of ca. 5.5 bar at room temperature. Solid LiAlH₄ and MgCl₂ are placed together in the left hand limb of the H-tube, along with a glass-coated magnetic stirrer flea. The apparatus is evacuated, and the left hand limb cooled to −196° C. with liquid nitrogen, and Me₂O is admitted from a cylinder. The Me₂O vapor immediately condenses in the left hand limb. The apparatus is sealed and allowed to warm to room temperature behind a safety shield. The slurry in the left hand limb is stirred at room temperature for several hours, at which point the liquid has become more viscous. The liquor is then decanted into the bridge and onto the frit. Gentle cooling of the right hand limb using liquid nitrogen draws the liquor through the frit, leaving behind a solid residue of LiCl and any Mg(AlH₄)₂ that was not dissolved in the Me₂O solvent. Cooling the left hand limb again with liquid nitrogen condenses Me₂O vapour onto this solid residue, leading to dissolution of the remaining Mg(AlH₄)₂; this can be extracted by repeated condensation-filtration cycles. Once extraction is complete, the apparatus is evacuated, leaving unwanted residues in the left hand limb and the desired product as a fine white powder in the right hand one. The purity of the product is assessed using powder X-ray diffraction.

### Example 2

Literature methods describing the preparation of the trisodium hexahydroaluminate, Na₃AlH₆, avoid coordinating ether solvents, presumably on account of the issues described above for magnesium alanate. Instead, hydrocarbon solvents are employed, and high temperatures and hydrogen pressures are necessary to stabilize the desired product, as described in Eqs. 8 and 9.

However, using Me₂O as a reaction medium, we have carried out the synthesis of Na₃AlH₆ cleanly and repeatably at moderate temperatures and with no added hydrogen, as detailed in Eq. 10.

$$\begin{matrix}{NaAlH}_{4} + 2 NaH {{}_{toluene}}^{160 ° C . ; 140 bar {H}_{2 }} {Na}_{3} {AlH}_{6} & Eq . 8 \\ {NaAlH}_{4} + 2 NaH {{}_{hexane}}^{165 ° C . ; 300 bar {H}_{2 }} {Na}_{3} {AlH}_{6} & Eq . 9 \\ {NaAlH}_{4} + 2 NaH {{}_{{Me}_{2} O}}^{80 ° C . } {Na}_{3} {AlH}_{6} & Eq . 10\end{matrix}$$

Eq. 10 and reactions having a mechanism similar to or analogous to Eq. 10 can be referred to as a complexation reaction.

The reaction is carried out in a 250 mL stainless-steel pressure reactor. NaAlH₄ and NaH are added to the vessel in a 1:2 ratio; then the vessel is cooled to −78° C. with dry ice, and Me₂O is admitted. The amount of Me₂O admitted to the vessel may be monitored by weighing the storage container before and after transfer; typically 50 g of the solvent is used. The reactor is then sealed, and the contents warmed to 80° C. and stirred mechanically for a period of 4 h. The solvent is vented, leaving Na₃Al₆ as a fine white powder. The purity of the product is confirmed by powder X-ray diffraction. Table 1 sets forth the experimental conditions used in the synthesis in various embodiments.

TABLE 1
Experimental Conditions for the Synthesis of Na₃AlH₆.

| Expt. | | | Reaction |
|---|---|---|---|
| No. | Experimental Conditions | T/° C. | Time/h |
| 1 | Mechanochemical | 20 | 12 |
| 2 | Me₂O (50 g) | 80 | 12 |
| 3 | scMe₂O (50 g) | 160 | 12 |
| 4 | scMe₂O (50 g) + H₂ (20 bar) | 160 | 12 |

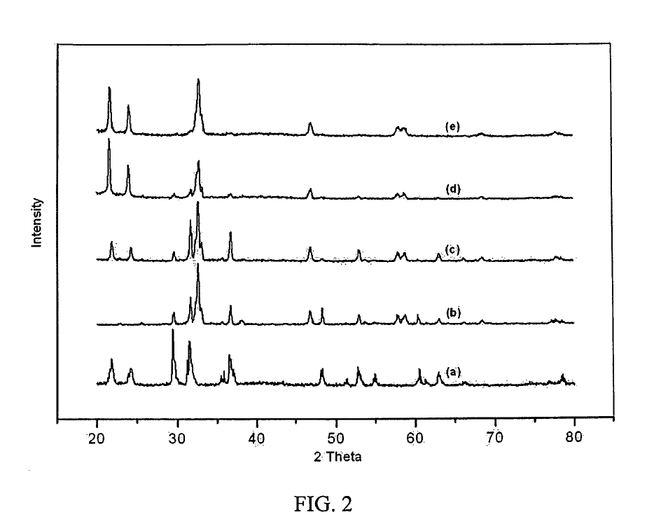

The reaction products were characterized using powder XRD, with the results shown in FIG. 2, in which a number of x-ray diffraction patterns are shown. These show that the mechanochemical synthesis (Expt. 1) proceeds to completion to produce Na₃AlH₆ with 100% purity, whereas the samples prepared using Me₂O as a reaction medium show traces of NaAlH₄ impurity. Comparison of the results obtained using Me₂O as a solvent (Expts. 2-4) shows that the Na₃AlH₆ formed under the most forcing conditions (160° C. and 20 bar H₂; Expt. 4) yielded the product in most pure form (99%).

In FIG. 2 the conditions of synthesis corresponding to each of the curves (a) through (e) are as follows: Curve (a) 2NaH+NaAlH₄ reactant mixture; Curve (b) 2NaH+NaAlH₄ reacted in Me₂O at 80° C. for 12 h; Curve (c) 2NaH+NaAlH₄ reacted in Me₂O at 160° C. for 12 h; Curve (d) 2NaH+NaAlH₄+20 bar H₂ reacted in Me₂O at 160° C. for 12 h; and Curve (e) 2NaH+NaAlH₄ reacted mechanochemically at 20° C. for 12 h.

### Example 3

The direct reaction between aluminum metal and hydrogen to form alane, AlH₃, is extremely difficult to engineer under normal conditions, owing to the high dissociation pressure of alane (ca. 10⁵ bar at ambient temperatures). However, it is anticipated that the stability endowed on the product by use of a donor solvent like Me₂O will allow achievable pressures of H₂ to be used to effect the direct reaction of H₂ with Al, as described in Eq. 11, exploiting the stability of the Lewis acid-base complex to favor the reaction. The Al may be activated with small amounts of a transition metal catalyst like Ti. Once the reaction has occurred, the reaction vessel can be vented, removing the excess H₂ and Me₂O as gases. Any final vestiges of Me₂O coordinated to the AlH₃ product, may be driven from the complex by gentle heating, to leave solvent-free AlH₃ as described in Eq. 12.

$$\begin{matrix}{Al}_{( s )} + 1.5 {H}_{2 ( g )} {{}_{{Me}_{2} O}}^{ca . 80 ° C . , {H}_{2} ca .50 bar } {( {Me}_{2} O )}_{n} \cdot {AlH}_{3 ( solv )} \\ ( n = 1 or 2 ) & Eq . 11 \\ {( {Me}_{2} O )}_{n} \cdot {AlH}_{3 ( solv )} {{}_{- {Me}_{2} O }}^{50 ° C .} {AlH}_{3 ( s )} & Eq . 12\end{matrix}$$

Eq. 11 and reactions having a mechanism similar to or analogous to Eq. 11 can be referred to as a direct reaction to form a metal hydride.

### Example 4

Direct formation of LiAlH₄ from LiH, Al and H₂ would represent a preferable synthesis for this versatile and ubiquitous reagent. Lithium aluminum hydride releases 7.9 wt % hydrogen at relatively low temperatures, according to Eqs. 13 and 14.

3LiAlH₄₍ₛ₎→Li₃AlH₆₍ₛ₎+2 Al+3H₂(g) Eq. 13

Li₃AlH₆₍ₛ₎→3LiH₍ₛ₎+Al+1.5H₂(g) Eq. 14

However, Eq. 13 is exothermic and has a positive entropy, meaning that it is thermodynamically irreversible. In other words, the thermodynamic variables of pressure and temperature cannot be used to force Li₃AlH₆, Al and H₂ to react to form LiAlH₄.

It is anticipated that by carrying out this reaction in a donor solvent like Me₂O, the solvation enthalpy of the product (i.e. complexation of Li⁺) will be sufficient to reverse the unfavorable thermodynamics, permitting direct formation of LiAlH₄ from LiH and Al, according to Eq. 15. Although the preparation of LiAlH₄ from LiH, Al and H₂ (i.e., the operation of Eqs. 13 and 14 in reverse direction) has been reported in the literature using conventional solvents Et₂O (b.p.+35° C.) and THF (b.p.+55° C.), yields are low and the product remains contaminated with coordinated solvent. The Al may be activated with small amounts of a transition metal catalyst like Ti. Once the reaction has occurred, the reaction vessel can be vented, removing the excess H₂ and Me₂O as gases. Any final vestiges of Me₂O coordinated to the LiAlH₄ product, may be driven from the complex by gentle heating, to leave solvent-free LiAlH₄ as described in Eq. 16.

$${LiH}_{( s ) +} {Al}_{( s )} {{}_{{Me}_{2} O}}^{ca . 80 ° C . , {H}_{2} ca .50 bar } {LiAlH}_{4} \cdot {n Me}_{2} {O}_{( s )} \qquad Eq . 15$$

Eq. 15 and reactions having a mechanism similar to or analogous to Eq. 15 can be referred to as a direct reaction to form a complex metal hydride. The reactions described herein are expressed using a specified solvent or reaction medium. However, it is believed that suitable solvents or reaction media for use in synthesis reactions as contemplated herein can include any of dimethyl ether, Me₂O (b.p. −25° C.); ethyl methyl ether, MeOEt (b.p.+11° C.); epoxyethane, C₂H₄O (b.p.+10° C.), and trimethylamine, Me₃N (b.p.+3° C.).

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A process for preparation of a hydrogen storage material, comprising the steps of:
providing a reagent comprising a metal to be incorporated into the hydrogen storage material;
providing a source of hydrogen configured to provide hydrogen as a reagent to be incorporated into the hydrogen storage material;
providing a solvent or reaction medium having a boiling point below 25° C.; and
reacting said hydrogen reagent with said reagent comprising a metal in said solvent or reaction medium;
thereby generating a quantity of hydrogen storage material.

2. The process for preparation of a hydrogen storage material of claim 1, wherein said hydrogen storage material comprises a selected one of Mg(AlH₄)₂, Na₃AlH₆, AlH₃, and LiAlH₄.

3. The process for preparation of a hydrogen storage material of claim 1, wherein said solvent or reaction medium having a boiling point below 25° C. is a selected one of dimethyl ether, ethyl methyl ether, epoxyethane, and trimethylamine.

4. The process for preparation of a hydrogen storage material of claim 1, wherein said step of reacting said hydrogen reagent with said reagent comprising a metal in said solvent or reaction medium comprises a metathesis reaction.

5. The process for preparation of a hydrogen storage material of claim 1, wherein said step of reacting said hydrogen reagent with said reagent comprising a metal in said solvent or reaction medium comprises a complexation reaction.

6. The process for preparation of a hydrogen storage material of claim 1, wherein said step of reacting said hydrogen reagent with said reagent comprising a metal in said solvent or reaction medium comprises a direct reaction between hydrogen and a metal to form a metal hydride.

7. The process for preparation of a hydrogen storage material of claim 1, wherein said step of reacting said hydrogen reagent with said reagent comprising a metal in said solvent or reaction medium comprises a direct reaction between hydrogen and a metal to form a complex metal hydride.

8. The process for preparation of a hydrogen storage material of claim 1, further comprising the step of removing an adduct molecule of said solvent or reaction medium from said hydrogen storage material to provide said hydrogen storage material in a substantially pure form.
